(19) United States
(12) Patent Application Publication
(10) Pub. No.: US 2010/0270809 A1
(43) Pub. Date: Oct. 28, 2010

(54) WIND TURBINE WITH ROTATING HYDROSTATIC TRANSMISSION SYSTEM

(75) Inventor: Ole Gunnar Dahlhaug, Trondheim (NO)

Correspondence Address: BIRCH STEWART KOLASCH & BIRCH, PO BOX 747, FALLS CHURCH, VA, 22040-0747, US

(73) Assignee: CHAPDRIVE AS, Trondheim (NO)

(21) Appl. No.: 12/742,605

(22) PCT Filed: Nov. 7, 2008
(86) PCT No.: PCT/NO2008/000392

§ 371 Date: Jul. 1, 2010

Related U.S. Application Data
(60) Provisional application No. 60/996,354, filed on Nov. 13, 2007.

(30) Foreign Application Priority Data
Nov. 13, 2007 (NO) 20075826

(51) Int. Cl. F03D 11/02; F03D 9/00

(52) U.S. Cl. 290/55

(57) ABSTRACT

A wind turbine power production system (1) with a closed loop hydrostatic transmission system (10) for the transfer of mechanical energy from a wind turbine rotor (2) to an electric generator (20) where the hydrostatic transmission system (10) comprises a closed loop with a pump (11) and a motor (12) connected by tubes or pipes (13, 14). The assembly of the hydrostatic transmission system (10) and the turbine rotor (2) is arranged to rotate about a vertical axis (8), and the rotating motor (12) is arranged on or near the ground in the tower (4).

### TECHNICAL FIELD

The invention relates to a turbine driven electric power production system with a closed loop hydraulic transmission system for the transfer of mechanical energy from a wind turbine to an electric generator. As opposed to conventional wind turbine systems comprising mechanical speed-up gears where the generator is arranged in the nacelle of the wind turbine power production system, the hydraulic motor and the generator in the present invention are arranged on the ground or close to the ground and components of the hydrostatic transmission system, including the hydraulic motor rotates with the nacelle.

The location and weight of the drive train and the generator is becoming increasingly important for the installation and maintenance as the delivered power and the size of the wind turbine is increasing.

Considering that about 30% of the downtime for a conventional wind turbine is related to the mechanical gearbox, the weight of a 5 MW generator and the associated mechanical gear is typically 50 000 to 200 000 kg, and that the centre of the wind turbine rotor extends 100 to 150 m above the ground or sea level, it is easy to understand that the deployment and maintenance of conventional systems with mechanical gears and generator in the nacelle is both costly and difficult.

In the present invention rigid tubes or pipes can be used throughout the system all the way from the hydraulic pump in the tower to the hydraulic motor driving the generator in the base of the tower, while still being able to rotate the nacelle and the turbine rotor freely as the direction of the wind changes.

### BACKGROUND ART

In conventional wind turbine power production systems the energy from the wind is transferred mechanically, either directly or by a rotational speed-up gear to an electric generator.

The generator must rotate at a nominal speed to be able to deliver electricity to the grid or network connected to the power production system. If, during low wind speed conditions, the turbine is not supplying an appropriate level of mechanical torque to the system it will fail to deliver energy and instead the generator will act as an electric motor and the net will drive the generator and turbine through the mechanical gear.

On the other hand, if the wind is too strong the angular speed of the wind turbine rotor may become too high for the generator to operate properly or the mechanical apparatus could break down due to the strong forces.

Several solutions exist for overcoming the problems related to varying wind conditions. The most obvious solution is to stall and/or brake the turbine or pitch the turbine blades when the wind is too strong. Manual brakes and pitch control of the turbine blades are in use today, however, this solution may lower the efficiency of the system.

A well known solution from background art is the use of inverters to convert the output frequency of the electric generator to a desired frequency. The generator driven by the turbine will then be allowed to run at a variable angular speed depending on the wind speed. The use of inverters may be costly and may reduce the overall efficiency of the system.

It is known from background art that mechanical transmission systems based on planetary gears with variable gear ratio can be employed to maintain the generator rotational speed close to a desired value during varying wind conditions.

In U.S. patent application 2005/194787 and international patent application WO2004/088132 a wind turbine where the transfer of energy from the turbine to the generator is mechanically gear driven is described. The gear ratio can be varied by varying the rotational speed and direction of the outer ring of the planetary gear. In these applications a hydrostatic transmission system is used for controlling the planetary gear.

It has been proposed in several publications to use a hydrostatic transmission system comprising a hydraulic pump and a hydraulic motor for transferring energy from the turbine to the generator. By employing a hydraulic pump and/or motor with variable displacement, it is possible to rapidly vary the gear ratio of the hydraulic system to maintain the desired generator speed under varying wind conditions.

Japanese patent application JP 11287178 by Tadashi, describes a hydraulic transmission system used for the transfer of energy from a wind turbine rotor to an electric generator where the generator speed is maintained by varying the displacement of the hydraulic motor in the hydrostatic transmission system.

Hydrostatic transmission systems allow more flexibility regarding the location of the components than mechanical transmissions.

The relocation of the generator away from the top portion of the tower in a wind turbine power production system removes a significant part of the weight from the top portion of the tower. Instead the generator may be arranged on the ground or in the lower part of the tower. Such an arrangement of the hydrostatic motor and the generator on the ground level will further ease the supervision and maintenance of these components, because they may be accessed at the ground level.

International patent application 94/19605A1 by Gelhard et al. describes a wind turbine power production system comprising a mast on which is mounted a propeller which drives a generator. The power at the propeller shaft is transmitted to the generator hydraulically. The propeller preferably drives a hydraulic pump which is connected by hydraulic lines to a hydraulic motor driving the generator. The hydraulic transmission makes it possible to locate the very heavy generator in a machinery house on the ground. This reduces the load on the mast and thus makes it possible to design the mast and its foundation to be lighter and cheaper.

A trend in the field of so-called alternative energy is that there is a demand for larger wind turbines with higher power. Currently 5 MW systems are being installed and 10 MW systems are under development. Especially for off-shore installations far away from inhabitated areas larger systems may be environmentally more acceptable and more cost effective. In this situation the weight and maintenance access of the components in the nacelle of the wind turbines is becoming a key issue. Considering that about 30% of the downtime for a conventional wind turbine is related to the mechanical gearbox, the weight of a 5 MW generator and the associated mechanical gear is typically 50 000 to 200 000 kg and that the centre of the turbine stretches 100 to 150 m above the ground or sea level, it is easy to understand that the deployment and maintenance of conventional systems with mechanical gears and generator in the nacelle is both costly and difficult.

Hydraulic swivels have been proposed for being able to direct the nacelle into the wind continuously in U.S. Pat. No. 7,183,664 (McClintic) and DE 3025563 (Suzzi). However, hydraulic swivels may suffer from leakage and reduced efficiency and an inventive solution with less moving hydraulic parts is needed.

### SHORT SUMMARY OF THE INVENTION

A wind turbine power production system with a closed loop hydrostatic transmission system for the transfer of mechanical energy from a wind turbine rotor to an electric generator where the hydrostatic transmission system comprises a closed loop with a pump and a motor connected by tubes or pipes. The assembly of the hydrostatic transmission system and the turbine rotor is arranged to rotate about a vertical axis, and the rotating motor is arranged in the base of the tower. According to embodiments of the invention, the motor may be arranged on or near the ground when the turbine is on-shore or near or below the sea surface when the system is off-shore or near-shore.

### BRIEF DESCRIPTION OF DRAWINGS

The invention is illustrated in the attached drawing figures meant to illustrate preferred and alternate embodiments of the invention. The drawings shall not be construed to limit the scope of the invention which shall solely be limited by the attached claims.

FIG. 1 illustrates a simplified vertical section of a wind turbine power production system of the background art where a mechanical gear box and a generator are arranged in the nacelle, and the power cables and signal cables extend from the nacelle to the bottom of the tower.

FIG. 2 illustrates in a similar fashion to FIG. 1, a section of a wind turbine power production system of the background art where a hydrostatic transmission system and a generator are arranged in the nacelle and the hydrostatic transmission system is used as a variable gear. As in FIG. 1 the power cables and signal cables extend from the nacelle to the bottom of the tower.

FIG. 3 illustrates a schematic vertical section of a wind turbine power production system according to the invention wherein the hydraulic motor and generator are located in the base of the tower or near the ground and a hydraulic motor rotation actuator rotates the hydraulic motor with the yaw of the nacelle.

FIG. 4 illustrates a vertical section of a wind turbine power production system similar to FIG. 3, with the difference that the hydraulic disk brake from background art is replaced by a valve flow brake.

FIG. 5 illustrates a schematic vertical section of a wind turbine power production system according to the invention wherein the hydraulic motor and generator are located in the base of the tower or near the ground and a generator rotation actuator rotates the generator and the hydraulic motor with the yaw of the nacelle.

FIG. 6 illustrates a diagram of a hydrostatic transmission system comprised in a power production system according to an embodiment of the invention.

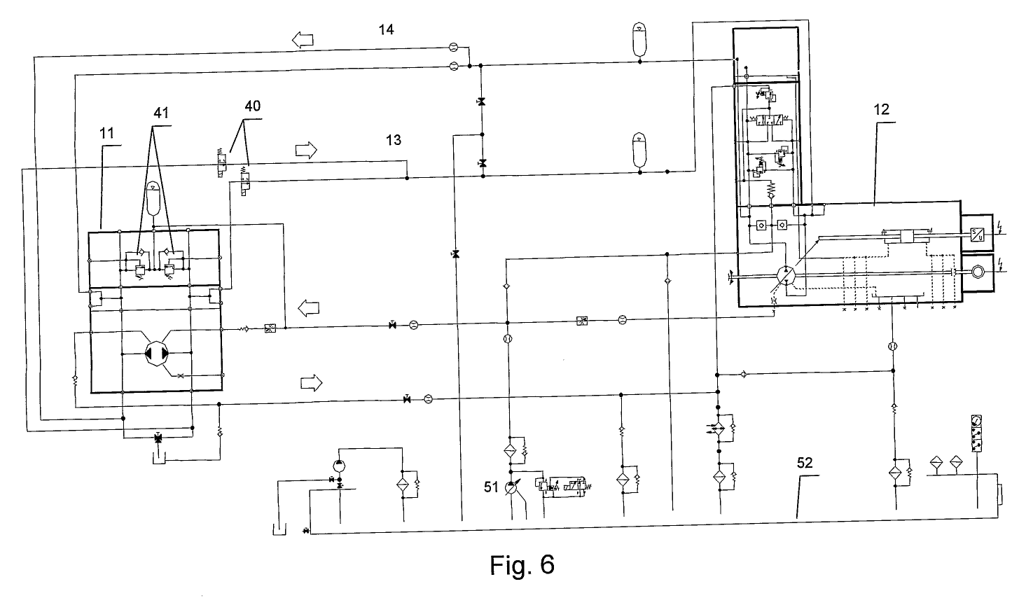

FIG. 7 illustrates a simplified cross-section of a disk-shaped electrical swivel. FIG. 7a illustrates an electrical swivel with coils and inductive transfer, while FIG. 7b shows an electrical swivel with electrical transfer based on slip rings and brushes. FIG. 7c illustrates an axial view of the disk-shaped electrical swivel with coils.

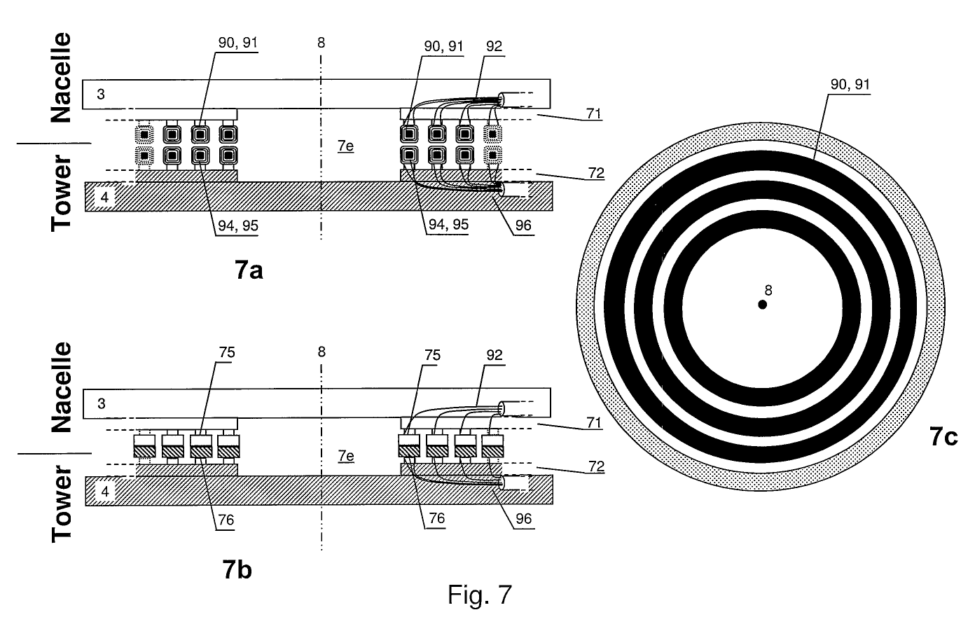

FIG. 8 illustrates schematically some embodiments of the invention. In FIG. 8a the wind turbine rotor and hydrostatic system rotates about the generator shaft. In FIGS. 8b and 8c a gear is arranged between the hydraulic motor and the generator. In FIG. 8b the wind turbine rotor and the hydrostatic system rotates about a vertical axis that coincides with the shaft of the hydraulic motor and in FIG. 8c the wind turbine rotor and the hydrostatic system rotates about a vertical axis that coincides with the shaft of the generator. In FIG. 8d the wind turbine rotor and the hydrostatic transmission system rotates about a vertical gear shaft where the gear drives one or more generators.

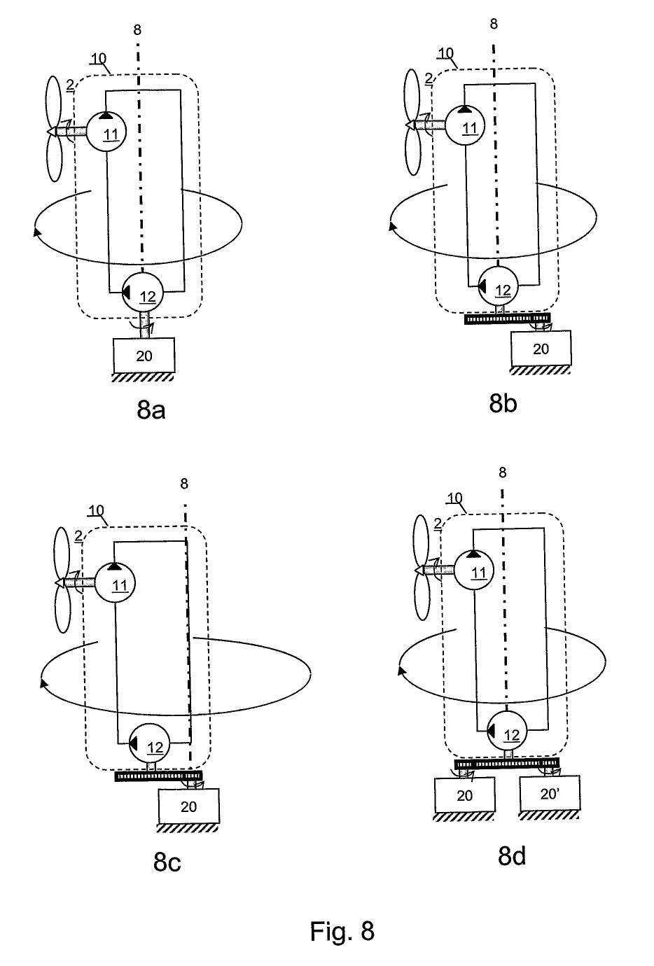

FIG. 9 illustrates schematically how the pipes or tubes between the hydraulic pump and the hydraulic motor are supported in a tube in FIG. 9a, or with support elements, in FIG. 9b.

### EMBODIMENTS OF THE INVENTION

The invention will in the following be described referring to the attached figures and will describe a number of embodiments according to the invention. It should be noted that the invention should not be limited to the embodiments described in this disclosure, and that any embodiments lying within the spirit of this invention should also be considered part of the disclosure.

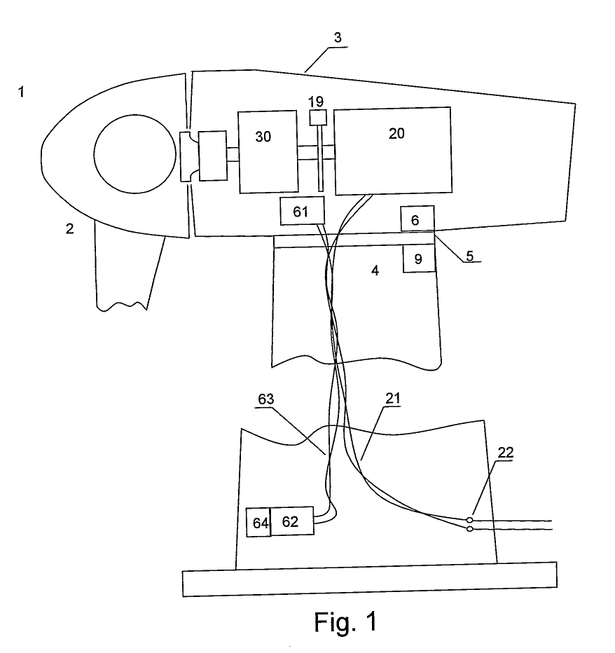

Referring firstly to FIG. 1 of the drawings in which is shown a cross section view of a wind turbine power production system (1) according to background art. The wind power production system (1) comprises a wind turbine rotor (2) with a mechanical gear box (30) and an electric generator (20) for the transfer of mechanical energy from the wind turbine rotor (2) to electric energy from the generator (20). The gear box (30) and the generator (20) are arranged in a nacelle (3) on the top of a tower (4) of known design. The nacelle is arranged on a rotating bearing (5) so that wind turbine rotor (2) and nacelle (3) can pivot at the top of the tower (4), where the yaw of the nacelle is controlled by a yaw control system (6). The main task of the yaw control system (6) is to continuously point the wind turbine rotor (2) into the wind (or away from the wind). The electric power from the generator (20) is transported by the power cables (21) between the generator (20) and the electrical power terminations (22). The system may also comprise electric signal cables (63) that furnish control signals and power from a base control unit (62) to a nacelle control unit (61) or directly to the components of the nacelle and electric signal cables (63) that furnish measurements signals from the nacelle control unit (61) or directly from the components of the nacelle to the base control unit (62).

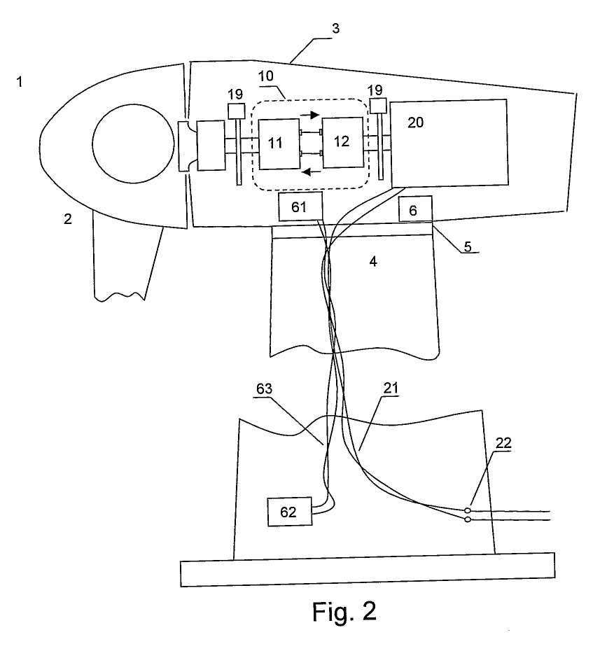

FIG. 2 illustrates a vertical section of a wind turbine power production system (1) with a hydrostatic transmission system (10) used as a variable gear according to background art, for the transfer of mechanical energy from the wind turbine rotor (2) to electric energy from the generator (20). Similar to FIG. 1 the nacelle is arranged on a rotating bearing (5) with a vertical axis so that the wind turbine rotor (2) and nacelle (3) can pivot at the top of the tower (4), where the yaw of the nacelle is controlled by a yaw control system (6). The main task of the yaw control system (6) is to continuously point the wind turbine rotor (2) into the wind (or away from the wind). The system may also comprise electrical signal and power cables as shown in FIG. 1.

It is well known by a person skilled in the art that the downtime of the mechanical gearbox used in systems according to background art as depicted in FIG. 1 may constitute as much as 30% of the downtime for a conventional wind turbine. In addition the weight of a 5 MW generator and the associated mechanical gear is typically 50 000 to 200 000 kg. When the centre of the turbine extends 100 to 150 m above the ground or above sea level, in the case of off-shore or near shore installations, it is understood by a person skilled in the art that the construction, deployment and maintenance of conventional systems with mechanical gears and generator in the nacelle is both costly and difficult.

A major issue with the systems according to background art as shown in FIGS. 1 and 2 is that the wind turbine should preferably be continuously pointed into the wind by the yaw control system (6). The power cables (21) and signal cables (63) may then become progressively twisted if the turbine keeps rotating in the same direction for some time until a twist limit is reached. After some turns in one direction the turbine has to be brought back to its initial position. A twist counter (64) will indicate to the control system (62) when it is time to unwind the cables. This may require a planned production stop and restart.

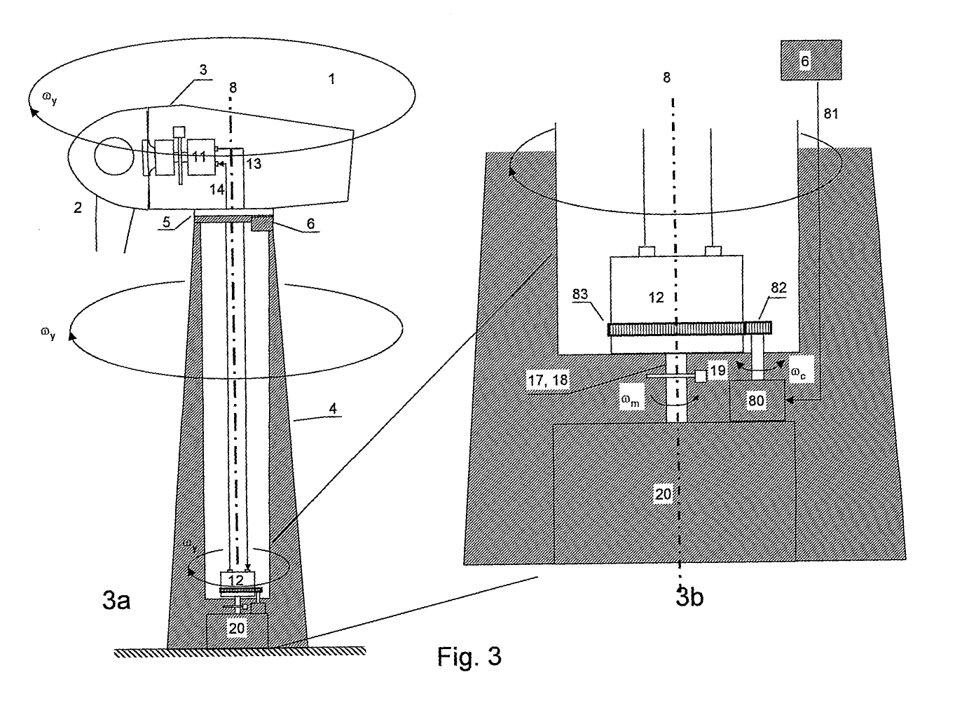

FIG. 3 illustrates a vertical section of a wind turbine power production system (1) according to the invention with a closed loop hydrostatic transmission system (10) for the transfer of mechanical energy from a wind turbine rotor (2) to an electric generator (20). The hydrostatic transmission system (10) comprises a closed loop with a pump (11) and a motor (12) connected by tubes or pipes (13, 14).

In the present invention rigid tubes or pipes (13,14) can be used throughout the system all the way from the hydraulic pump (11) in the tower to the hydraulic motor (12) driving the generator (20) in the base of the tower (4), while still being able to rotate the nacelle (3) and the turbine rotor (2) freely as the direction of the wind changes.

In an embodiment of the invention the assembly of said hydrostatic transmission system (10) and said turbine rotor (2) is arranged to rotate about a vertical axis, and the rotating motor (12) is arranged in the base of said tower (4). In FIG. 3a the shaded areas illustrate components such as a tower (4) and an electric generator (20) of the power production system (1) fixed relative the ground. The wind turbine rotor (2), the nacelle (3) and the hydraulic motor (12) rotate with an angular speed (ω_{y}) about a vertical axis (8) that coincides with the shaft of the electric generator (20). As can be understood from the figure, the nacelle is arranged on top of a rotary bearing (5), allowing the nacelle to pivot on top of the tower (4), where the yaw of the nacelle is controlled by a yaw control system (6). The main task of the yaw control system (6) is to continuously point the wind turbine rotor (2) into the wind (or away from the wind).

The lower part of the power production system of FIG. 3a is further detailed in FIG. 3b where the hydraulic motor (12) of the hydrostatic transmission system (10) is shown pivoting on top of the generator (20). The rotation of the hydrostatic motor relative the fixed generator may be forced by the yaw of the nacelle (3) by arranging a hydraulic motor rotation actuator (80) that is able to rotate the hydraulic motor (12) with the yaw of the nacelle (3) by employing yaw position signals (81) from the yaw control system (6) or by receiving incremental/decremental or angular yaw position signals by any other yaw position measurement system as will be understood by a person skilled in the art.

In this embodiment of the invention the hydraulic motor rotation actuator (80) is fixed to the tower and the generator and rotates the hydraulic motor in either direction by driving a mechanical gear comprising a first cog wheel (82) arranged on the output shaft of the actuator (80) and a second cog wheel (83) arranged fixed around the hydraulic motor (12). When the yaw control system (6) moves the nacelle in either direction a signal (81) is sent to, or detected by the actuator (80) that will rotate the first cog wheel (82) with an angular speed (ω_{c}) and direction, and consequently the second cog wheel (83) and the hydraulic motor (12) with an angular speed (ω_{y}) and direction similar or close to the angular speed and direction of the nacelle. The signals (81) may be electrical by wire or wireless or any other type of signal as will be understood by a person skilled in the art.

In an embodiment of the invention the power production system may comprise a mechanical transmission system, including gears and drive shaft from the yaw control system (6) or the nacelle (3) to the hydraulic motor (12).

In an embodiment of the invention the power production system may comprise a mechanical transmission system, including a chain and a chain drive from the yaw control system (6) or the nacelle (3) to the hydraulic motor (12).

Further, It will be understood by a person skilled in the art that the mechanical implementation and arrangement of the components used for rotating the hydraulic motor (12) with the yaw of the nacelle (3) may be different from the example provided in FIG. 3 and the embodiments described above.

A wind turbine power production system according to the invention allows for the relocation of the generator and the hydraulic motor to the base of the tower. This significantly reduces the weight of the top portion of the tower.

The weight of a 5 MW generator and the associated mechanical gear is typically 50 000 to 200 000 kg. When the centre of the turbine extends 100 to 150 m above the ground or sea level, installation of such systems may become a critical issue. In order to mount the heavy components in the nacelle, large cranes capable of lifting the heavy weight components up to the nacelle may be needed. This problem may be solved by the present invention wherein heavy weight components such as the generator may be arranged anywhere in the tower or external to the tower, above or below the tower foundation (or above or below the sea level for off-shore or near shore installations). For near-shore or off-shore installations this is particularly advantageous because of the reduced problems related to the stability of both the crane and the wind turbine power production system that are depending on varying environmental conditions.

It is understood by a person skilled in the art that the weight of a 5 MW turbine, generator and the associated gear and support system at the height of the turbine center which may extend 100 to 150 m above ground or sea level, is the most important parameter for dimensioning the tower construction and the foundation or floating support of the tower and turbine. According to the present invention the generator and/or gearbox may be arranged on or below ground or sea level to reduce the weight at the turbine center. The dimensions and associated costs of the tower and the supporting system may therefore be reduced accordingly.

The arrangement of the hydrostatic motor and the generator near the ground or sea level will further significantly ease the accessibility and thereby the supervision and maintenance of these components. The downtime of the mechanical gearbox used in systems according to background art as depicted in FIG. 1 may constitute as much as 30% of the downtime for a conventional wind turbine. Manual inspection and supervision in the nacelle is difficult and has proven dangerous during power production. However, scheduled maintenance work may be more easily carried out if the components are located on the ground as illustrated in FIG. 3 for the present invention. Repairs and replacement of parts may also be significantly simpler when the generator and hydraulic motor are easily accessible near the ground (or near sea level). This becomes increasingly important with increasing nominal power delivered from the power production system and thus increasing diameter of the turbine and consequently increasing height of the tower and weight of the generator and components.

In this embodiment of the invention the problems related to continuously pointing the turbine into the changing wind direction without having to turn the turbine back to an initial angular position after a rotational angle limit, are solved by allowing the hydrostatic transmission system to rotate with the nacelle and arranging the generator near the ground or sea level. In the background art the turbine has to be rotated back to its initial position after some turns in one direction, in order to unwind the power cables, which requires a planned and costly production stop and restart.

In an embodiment of the invention the tubes or pipes (13, 14) between said pump (11) and said motor (12), are rigid tubes (13, 14). The elasticity of the closed loop is critical for the stability of the hydrostatic system, therefore fixed rigid pipes are preferred over flexible tubes since they do not suffer from deformations the same way that flexible tubes do.

In an embodiment of the present invention the pump shaft (27) of the pump (11) is connected directly to the turbine shaft (28) of said wind turbine rotor (2) without any intermediate gear box. This may reduce the total gear transmission loss.

The installation and maintenance costs of gear boxes in wind turbine power production systems are of major concern in the industry. Considering that about 30% of the downtime for a conventional wind turbine is related to the mechanical gearbox, and that the weight of mechanical gear boxes is a major contribution to the overall weight of the nacelle, it is obvious that a power production system without a mechanical gearbox will significantly reduce deployment and maintenance costs. The relatively short maintenance-free operating period of mechanical gear-boxes is of particular importance in off-shore and near-shore systems where maintenance of components in the nacelle 100-150 m above sea level is further complicated by the difficult environmental conditions and accessability in the areas of interest to the wind power industry. Installation and maintenance work is performed from ships or vessels, and depending on the weather conditions, maintenance work in the nacelle may be discouraged due to environmental conditions, since both the maintenance vessel and the wind turbine tower will have relative motion because of pitch, roll, yaw, surge, heave and sway movements. The difficult off shore and near shore conditions may result in even longer downtime for off-shore and near-shore installations than for similar on-shore installations if the gearbox fails.

The present invention reduceses this problem significantly by eliminating the gearbox in the nacelle and using the hydrostatic transmission system as the speed-up gear.

The turbine shaft (28) and the pump shaft (27) may be part of the same, common shaft or the two shafts may be welded or otherwise axially coupled by means of a sleeve or by any other proper fastening means as will be obvious to a person skilled in the art.

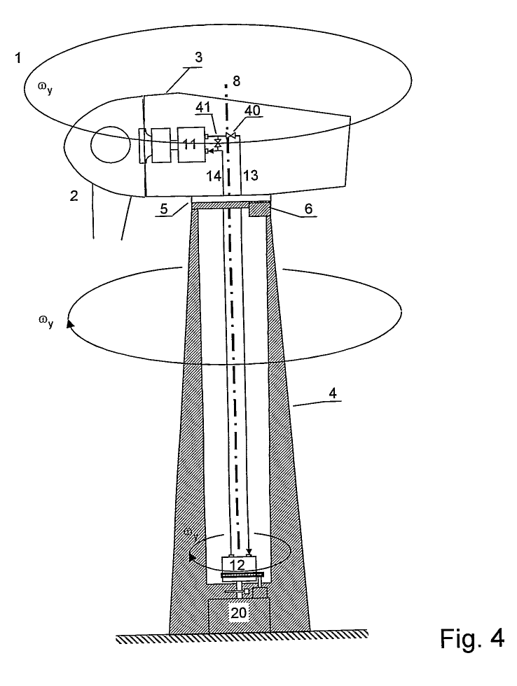

In an embodiment of the present invention the closed loop in the hydrostatic transmission system (10) comprises one or more valves (40, 41) arranged for stopping the fluid flow in the closed loop system (10) and thereby halting said wind turbine rotor (2) as illustrated in FIG. 4. In this embodiment of the invention the hydraulic brake (19) between the wind turbine rotor (2) and the hydrostatic transmission system (10) as shown in FIG. 2 may not be required. In general the flow brake according to the invention may be easier to install and maintain due to smaller dimensions and weight.

In an embodiment of the invention the motor (12) is arranged on or near the ground. In this embodiment of the invention the assembly of the hydraulic motor may be arranged above the ground or below the ground as will be understood by a person skilled in the art, depending on the local environment and mechanical construction.

In a marine embodiment of the invention the motor (12) is arranged near or below the sea level. The motor may be arranged somewhat above the sea level or below the sea level as will be understood by a person skilled in the art, depending on the local environment and mechanical construction. For near-shore and off-shore installations, a lower centre of gravity may stabilize the wind turbine power production system.

In an embodiment of the invention the generator shaft (17) of said generator (20) is directly connected to the motor shaft (18) of said hydraulic motor (12) as shown in FIG. 3. The motor shaft (18) and the generator shaft (17) may be part of the same, common shaft or the two shafts may be welded or coupled by means of a sleeve or by any other fastening means as will be obvious to a person skilled in the art. In this embodiment of the invention the assembly of the hydraulic motor and the generator may be arranged in the same housing inside the tower, external to the tower or below the base of the tower.

In an embodiment of the invention a motor shaft (17) of the motor (12) and a generator shaft (18) of the generator (20) are in a vertical position and a centre of the shafts (17, 18) coincides with the vertical axis (8), whereby the motor (12) is allowed to rotate about the vertical axis (8) when the generator (20) is fixed to the tower (4).

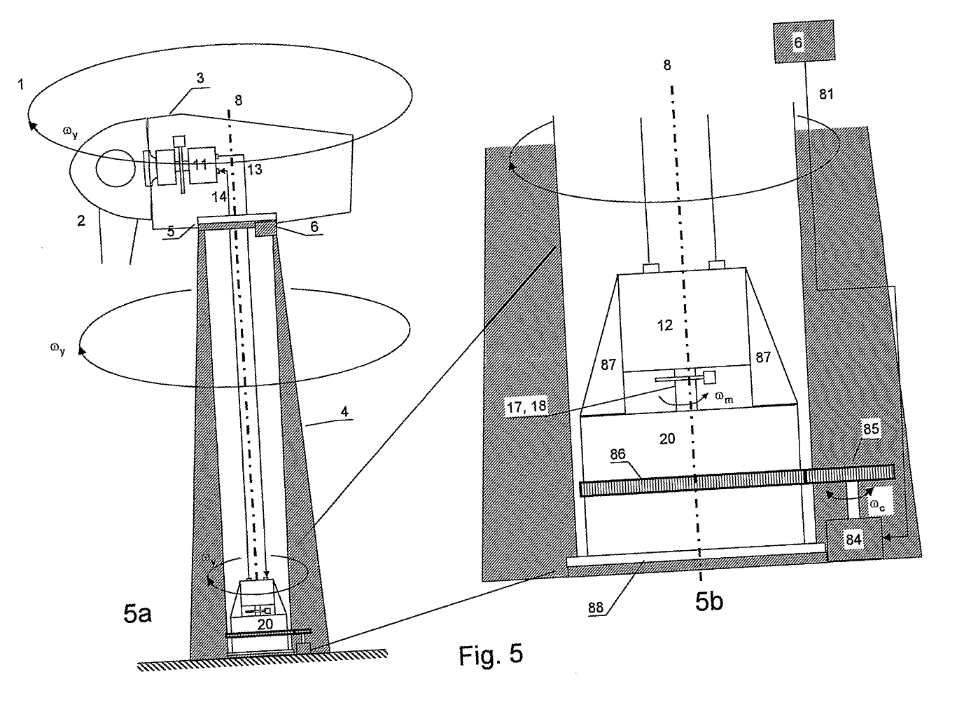

In an embodiment of the invention the generator (20) is arranged to rotate about said vertical axis (8). In this embodiment the generator rotates with the nacelle (3) and the hydrostatic system (10). The generator (20) may be arranged on a rotational bearing (88) on the ground or close to the ground, arranged to support the generator (20) as illustrated in FIG. 5. In FIG. 5a the shaded areas illustrate components such as a tower (4) and an electric generator (20) of the power production system (1) that are fixed relative the ground. The wind turbine rotor (2), the nacelle (3) and the hydraulic motor (12) rotate with an angular speed (ω_{y}) about a vertical axis (8) that coincides with the shaft of the electric generator (20). As can be understood from the figure, the nacelle is arranged on top of a rotary bearing (5), allowing the nacelle to pivot on top of the tower (4), where the yaw of the nacelle is controlled by a yaw control system (6). The main task of the yaw control system (6) is to continuously point the wind turbine rotor (2) into the wind (or away from the wind).

The lower part of the power production system of FIG. 5a is further detailed in FIG. 5b where the hydraulic motor (12) of the hydrostatic transmission system (10) is arranged on top of the generator (20). The generator housing and the hydraulic motor housing are fixed to each other by a fixing member (87). The fixing member (87) may be a bracket or any other coupling arranged for fixing the housing of the motor (12) to the housing of the generator (20) as is understood by a person skilled in the art. The rotation of the generator and hydrostatic motor relative the tower may be forced by the yaw of the nacelle (3) by arranging a rotation actuator (84) that is able to rotate the generator (20) and hydraulic motor (12) with the yaw of the nacelle (3) by employing yaw position signals (81) from the yaw control system (6) or by receiving incremental/decremental or angular yaw position signals by any other yaw position measurement system as will be understood by a person skilled in the art.

In this embodiment of the invention the rotation actuator (84) is fixed to the tower (4) and rotates the generator and hydraulic motor in either direction by driving a mechanical gear comprising a first cog wheel (85) arranged on the output shaft of the actuator (80) and a second cog wheel (86) arranged fixed around the generator (20). When the yaw control system (6) moves the nacelle in either direction a signal (81) is sent to, or detected by the actuator (84) that will rotate the first cog wheel (85) with an angular speed (ω_{c}) and direction, and consequently the second cog wheel (86) and the generator (20) and hydraulic motor (12) with an angular speed and direction (ω_{y}) similar to or close to the angular speed and direction of the nacelle. The signals (81) may be electrical by wire or wireless or any other type of signal as will be understood by a person skilled in the art.

In an embodiment of the invention the power production system (1) comprises an electric swivel (7e) arranged for transferring electrical signals.

The electrical signals may comprise electrical power from the turbine base below the swivel to power consuming components in the nacelle, control signals from a control unit to a pitch control actuator, signals from a control unit to a control actuator of the hydraulic pump, measurement signals from one or more sensors to a control unit or any other relevant electrical signals between the nacelle and the turbine base. The dimensions and number of electrical connections in the swivel depends on the application as will be obvious to a person skilled in the art.

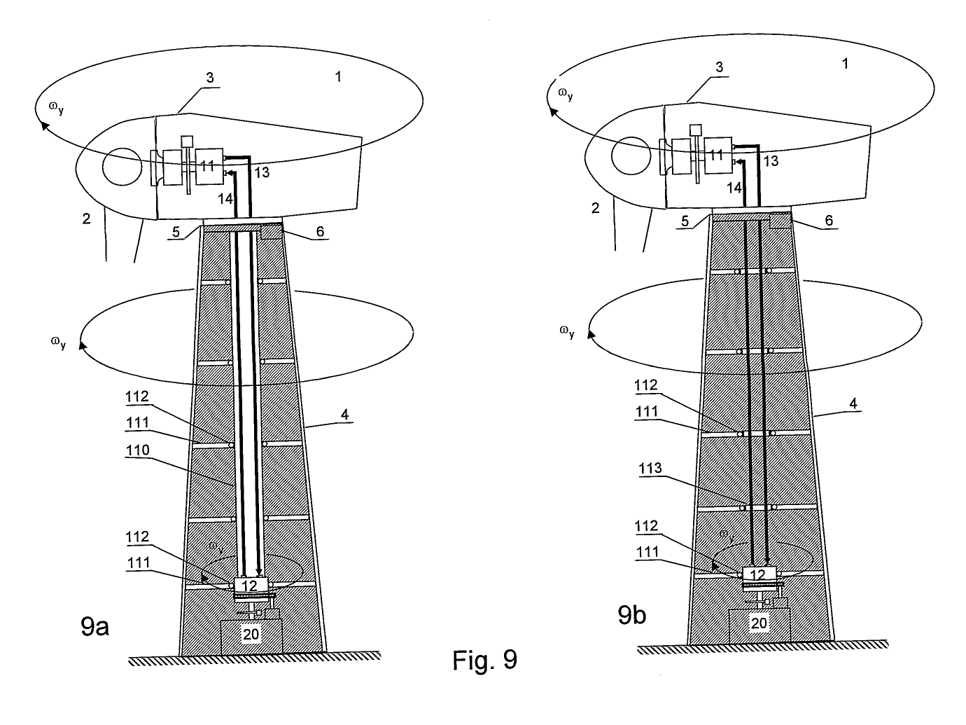

To reduce problems related to resonance of the tubes or pipes (13,14) between the hydraulic pump in the nacelle and the hydraulic motor in the foundation of the tower, a distance that may be up to 100 meters or more, the tower (4) comprises, in an embodiment of the invention, a tube (110), as shown in FIG. 9a, arranged for supporting the tubes or pipes (13,14), and further comprising one or more support elements (111) fixed to the tower (3), where the support elements are arranged for supporting the tube (110) in a lateral direction. The tube may extend through at least a part of the height of the tower, and may be filled with a material suitable for stabilizing the tubes or pipes (13,14) inside the tube (110), such as foam, fluid etc.

In a somewhat similar embodiment of the invention the tower (4) comprises one or more support disks (113), as shown in FIG. 9b, arranged for supporting the tubes or pipes (13,14), and further comprises one or more support elements (111) fixed to the tower (3), where the support elements are arranged for supporting the support disks (113) in a lateral direction. In this embodiment the disks (113) are arranged perpendicular to the tubes or pipes (13,14) with space inbetween to reduce the problems of low frequency resonance. Each disk is supported by support elements (111).

1.-12. (canceled)

13. A wind turbine power production system comprising a nacelle on top of a tower where said nacelle is arranged to rotate relative said tower about a mainly vertical axis, said wind turbine power production system further comprising a closed loop hydrostatic transmission system for the transfer of mechanical energy from a wind turbine rotor to an electric generator wherein said hydrostatic transmission system comprises a closed loop with a pump and a motor connected by tubes or pipes, where said pump is arranged in said nacelle and said motor is arranged in a base of said tower, wherein said motor is arranged to rotate with said nacelle.

14. The power production system according to claim 13, wherein said tubes or pipes between said pump and said motor, are rigid tubes.

15. The power production system according to claim 13, wherein a pump shaft of said pump is connected directly to a turbine shaft of said wind turbine rotor.

16. The power production system according to claim 13, wherein said closed loop comprises one or more valves arranged for stopping the fluid flow in the closed loop system and thereby halting said wind turbine rotor.

17. The power production system according to claim 13, wherein said motor is arranged on or near the ground.

18. The power production system according to claim 13, wherein said motor is arranged near or below the sea surface.

19. The power production system according to claim 13, wherein a generator shaft of said generator is directly connected to a motor shaft of said motor.

20. The power production system according to claim 13, wherein said generator is arranged to rotate about said vertical axis.

21. The power production system according to claim 13, wherein said power production system comprises an electric swivel arranged for transferring electrical signals.

22. The power production system according to claim 13, wherein a motor shaft of said motor and a generator shaft of said generator are in a vertical position and a centre of the shafts coincides with said vertical axis, whereby said motor is allowed to rotate about said vertical axis when said generator is fixed to said tower.

23. The power production system according to claim 13, said tower comprising a tube arranged for supporting said tubes or pipes, and further comprising one or more support elements fixed to said tower, said support elements arranged for supporting said tube in a lateral direction.

24. The power production system according to claim 13, said tower comprising one or more support disks arranged for supporting said tubes or pipes, and further comprising one or more support elements fixed to said tower, said support elements arranged for supporting said support disks in a lateral direction.
